(19) United States
(12) Patent Application Publication
(10) Pub. No.: US 2013/0047002 A1
(43) Pub. Date: Feb. 21, 2013

(54) DETECTION CIRCUIT FOR REDUNDANT POWER SUPPLY AND DETECTION METHOD THEREOF

(71) Applicant: YI-HONG LIU, Shenzhen City (CN)

(72) Inventor: YI-HONG LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/451,445

(22) Filed: Apr. 19, 2012

(30) Foreign Application Priority Data
Aug. 18, 2011 (CN) 201110237533.8

(51) Int. Cl. G06F 1/26; G06F 1/28

(52) U.S. Cl. 713/300

(57) ABSTRACT

A detection circuit employed in an electronic device includes an alternating current (AC) power source, a switch unit, a timer, a controller, and a baseboard management controller (BMC). The electronic device includes at least two power supply units. The controller is electronically connected between the timer and the switch unit. The timer outputs signals at predetermined intervals, the controller controls the switch unit to turn on/off according to the signals. The AC power source connects to/disconnect from the at least two power supply units through the switch unit accordingly. The BMC records a running states of the electronic device, and determines the running states of each of the at least two power supply units according to the recorded running states of the electronic device.

### BACKGROUND

1. Technical field

The disclosure generally relates to detection circuits, and more particularly relates to a detection circuit for redundant power supply and detection method thereof.

2. Description of the Related Art

Many electronic devices, such as servers, routers and like devices, adopt redundant power supply technology for providing power. These electronic devices often include at least two power supply units which are the same. When one power supply is disabled, the other power supply can be enabled for continuing to power the device. However, if an operator wants to detect whether the power supply units are operating normal, the operator must manually connect or disconnect the power supply units to an alternating current (AC) power source one at a time. This is very inconvenient for the operator.

Therefore, there is room for improvement within the art.

### BRIEF DESCRIPTION OF THE DRAWINGS

Many aspects of an exemplary detection circuit for redundant power supply and detection method thereof can be better understood with reference to the drawings. The components in the drawings are not necessarily drawn to scale, the emphasis instead being placed upon clearly illustrating the principles of the disclosure.

FIG. 1 is a block diagram of a detection circuit, according to an exemplary embodiment.

FIGS. 2-3 are flowcharts illustrating a detection method of the detection circuit in FIG. 1, according to an exemplary embodiment.

### DETAILED DESCRIPTION

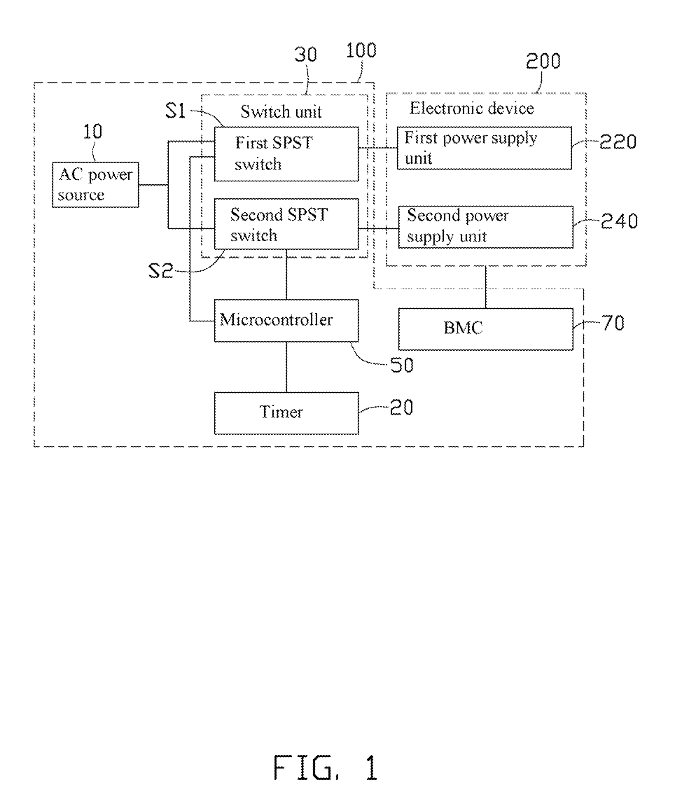

FIG. 1 shows a detection circuit 100, which can detect running states of power supplies in a redundant power supply system for an electronic device 200. The electronic device 200 can be a server, a router, for example. In one exemplary embodiment, the electronic device 200 includes a first power supply unit (PSU) 220 and a second power supply unit 240.

The detection circuit 100 includes an AC power source 10, a timer 20, a switch unit 30, a microcontroller 50, and a baseboard management controller (BMC) 70.

The timer 20 is electronically connected to the microcontroller 50 and outputs a pulse signal to the microcontroller 50 at predetermined intervals in a test period. In one exemplary embodiment, the predetermined interval is about 5 minutes, and the test period is about 12 hours.

In one exemplary embodiment, the switch unit 30 includes a first single-pole single-throw (SPST) switch S1 and a second SPST switch S2. The first SPST switch S1 is electronically connected between the AC power source 10 and the first power supply unit 220, and the second SPST switch S2 is electronically connected between the AC power source 10 and the second power supply unit 240. Both the first power supply unit 220 and the second power supply unit 240 can convert alternating current output from the AC power source 10 into direct current, for powering the electronic device 200.

The microcontroller 50 is electronically connected to the switch unit 30, for controlling the switch unit 30 according to the pulse signal from the timer 20. Specifically, the microcontroller 50 controls the first SPST switch S1 and the second SPST switch S2 to turn on/off, for connecting/disconnecting the AC power source 10 with the first power supply unit 220 and the second power supply unit 240.

The BMC 70 is electronically connected to the electronic device 200. The BMC 70 monitors and records running states of the electronic device 200 when the first power supply unit 220 or/and the second power supply unit 240 are disconnected or connected to the AC power source 10. The running states of the electronic device 200 indicate whether the electronic device 200 runs normally. For example, if the electronic device 200 runs within predetermined constraints (e.g., temperature constraints), the running state is determined to be normal, and if the electronic device 200 does not run within predetermined constraints or malfunctions, the running state is determined to be abnormal. Additionally, the BMC 70 determines whether the running states of the first power supply unit 220 and the second power supply unit 240 are normal according to the running state of the electronic device 200.

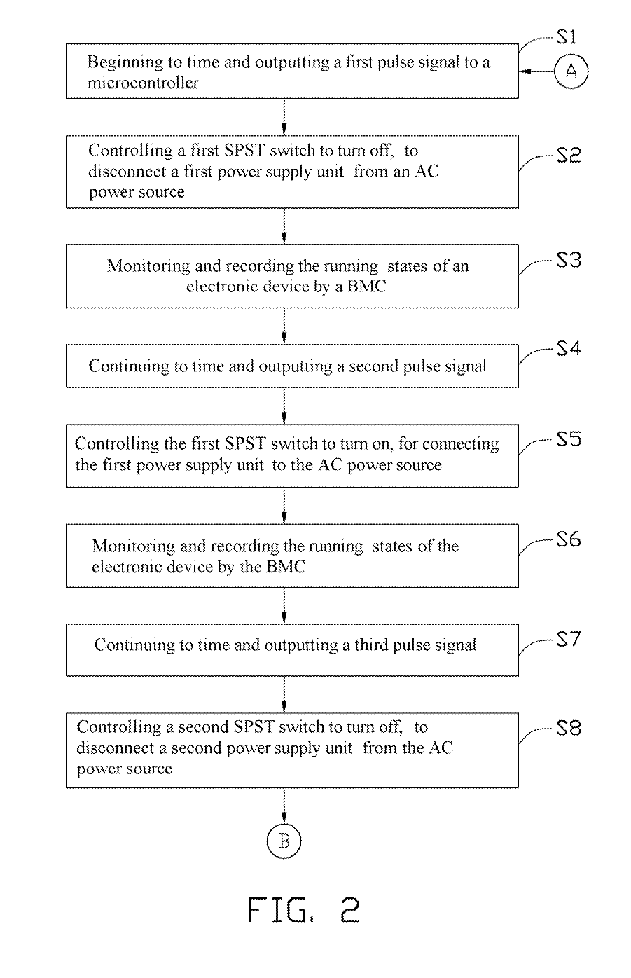

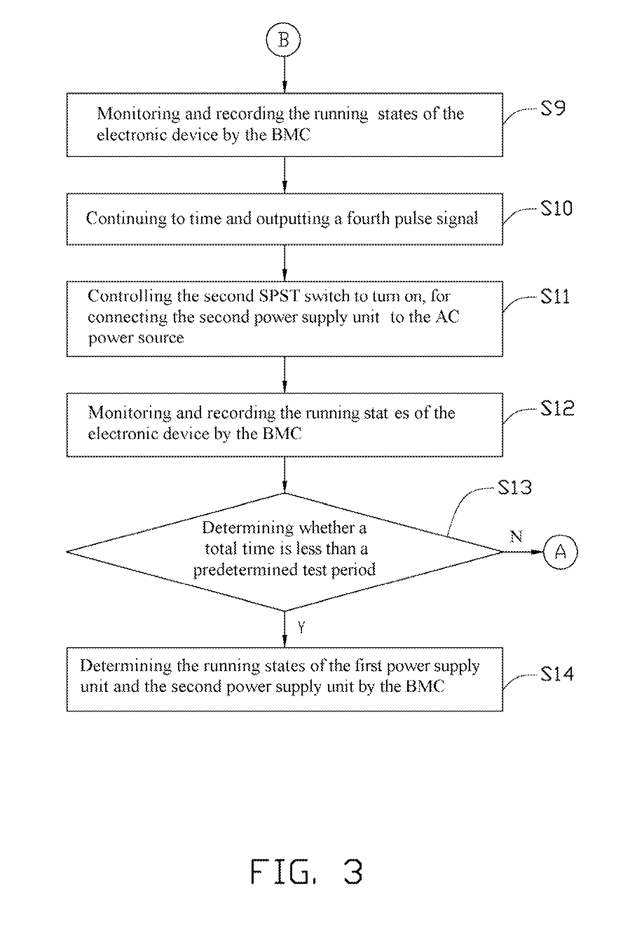

Also referring to FIGS. 2-3, a detection method of the aforementioned detection circuit 100 for redundant power supply is described according to an exemplary embodiment. The detection method includes at least following steps:

In step S1, the timer 20 begins to time, and outputs a first pulse signal to the microcontroller 50 after a predetermined time (e.g., 5 mins.).

In step S2, the microcontroller 50 receives the pulse signal and controls the first SPST switch 51 to turn off, to disconnect the first power supply unit 220 from the AC power source 10.

In step S3, the BMC 70 monitors and records the running states of the electronic device 200.

In step S4, the timer 20 outputs a second pulse signal after the same predetermined time.

In step S5, the microcontroller 50 receives the second pulse signal and controls the first SPST switch S1 to turn on, for electrically connecting the first power supply unit 220 to the AC power source 10.

In step S6, the BMC 70 monitors and records the running states of the electronic device 200.

In step S7, the timer 20 outputs a third pulse signal after the same predetermined time.

In step S8, the microcontroller 50 receives the third pulse signal and controls the second SPST switch S2 to turn off, to disconnect the second power supply unit 240 from the AC power source 10.

In step S9, the BMC 70 monitors and records the running states of the electronic device 200.

In step S10, the timer 20 outputs a fourth pulse signal after the same predetermined time.

In step S11, the microcontroller 50 receives the fourth pulse signal and controls the second SPST switch S2 to turn on, for electrically connecting the second power supply unit 240 to the AC power source 10.

In step S12, the BMC 70 monitors and records the running states of the electronic device 200.

In step S13, the timer 20 compares the total time during which pulse signals have been output with the test period. If the total time is less than the test period, the timer 20 continues to time, and step S1 is implemented. If the total time is equal to or more than the test period, step S14 is implemented.

In step S14, the timer 20 stops timing, and the BMC 70 determines whether the running states of the first power supply unit 220 and the second power supply unit 240 are normal according to the recorded running states of the electronic device 200. For example, if the electronic device 200 continues to run when the first power supply unit 220 is disconnected from the AC power source 10, but the electronic device 200 does not run or malfunctions when the first power supply unit 220 is connected to the AC power source 10, then the BMC 70 will determine that the running state of the first power supply unit 220 is abnormal.

In other embodiments, the switch unit 50 can be replaced by other apparatus or device which has switching function, such as a relay.

In other embodiments, the detection circuit 100 can detect more than two power supply units, and the number of SPST switches shall be consistent with the number of the power supply units.

The timer 20 outputs pulse signals to the microcontroller 30, and the microcontroller 30 controls the switch unit 50, so that the power supply units can be disconnected or connected to the AC power source 10. Thus, automatic and individual detection for all the power supply units of the electronic device 200 can be achieved, and the detection circuit 100 is both convenient and efficient.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A detection circuit for an electronic device comprising at least two power supply units, the detection circuit comprising:
an alternating current (AC) power source;
a switch unit electronically connected to the at least two power supply units and the AC power source;
a timer;
a microcontroller electronically connected between the timer and the switch unit; and
a baseboard management controller (BMC);
wherein the timer outputs signals at predetermined intervals and the microcontroller controls the switch unit to turn on/off according to the signals, and the AC power source connects to/disconnects from the at least two power supply units through the switch unit accordingly; and
wherein the BMC records running states of the electronic device when the AC power source connects to/disconnects from to the at least two power supply units, and determines the running states of each of the at least two power supply units according to the running states of the electronic device.

2. The detection circuit as claimed in claim 1, wherein the switch unit comprises at least two single-pole single-throw (SPST) switches, each SPST switch is electronically connected between one power supply unit and the AC power source.

3. The detection circuit as claimed in claim 1, wherein if the electronic device continues to run when the AC power source disconnects from a first power supply unit, but the electronic device malfunctions when the AC power source connects to the first power supply unit, the BMC determines that the running state of the first power supply unit is abnormal.

4. The detection circuit as claimed in claim 1, wherein the switch unit is a relay.

5. A detection method for a first power supply unit and a second power supply unit of an electronic device, comprising:
(a) controlling a first switch to disconnect the first power supply unit from an alternating current (AC) power source by a microcontroller;
(b) monitoring and recording a running states of the electronic device;
(c) controlling the first switch to connect the first power supply unit to the AC power source by the microcontroller;
(d) monitoring and recording the running states of the electronic device;
(e) controlling a second switch to disconnect the second power supply unit from the AC power source by the microcontroller,;
(f) monitoring and recording the running states of the electronic device;
(g) controlling the second switch to connect the second power supply unit to the AC power source by the microcontroller;
(h) monitoring and recording the running states of the electronic device;
(i) determining running states of the first and second power supply units according to the running states of the electronic device.

6. The detection method as claimed in claim 5, further comprising timing by a timer, and outputting a signal to the microcontroller after a predetermined time before the step (a), (c), (e), and (g).

7. The detection method as claimed in claim 6, further comprising:
determining whether a total time during which signals have been output is less than a predetermined test period;
continuing to time if the total time is less than the predetermined test period; and
stopping timing if the total time is equal to or more than the predetermined test period.
